(19) United States
(12) Patent Application Publication
(10) Pub. No.: US 2004/0058212 A1
(43) Pub. Date: Mar. 25, 2004

(54) Fuel cell having a preheating zone

(75) Inventors: Felix Blank, Konstanz (DE); Cosmas Heller, Friedrichshafen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/621,551

(22) Filed: Jul. 17, 2003

(30) Foreign Application Priority Data
Jul. 19, 2002 (DE) 102 32 870.6

(51) Int. Cl. H01M 8/04; H01M 8/10

(52) U.S. Cl. 429/26; 429/38; 429/30; 429/24; 429/13

(57) ABSTRACT

In a fuel cell the reaction area of the cell (bipolar plate) is divided. For startup, only a partial area of the bipolar plate is supplied with the reactants via separate inlet and outlet ports. This partial area thus heats up relatively rapidly due to its reduced size, and the resulting reaction heat may be transferred to adjacent reaction areas and/or used for heating. After reaching the operating temperature in these areas, the reactants may also flow over the adjacent reaction areas until achieving the full operating power of the fuel cell.

Priority is claimed to German Patent Application 102 32 870.6, the subject matter of which is hereby incorporated by reference herein.

The present invention relates generally to fuel cells, such as those used for modern zero-emission motor vehicles. In particular, the present invention relates to a fuel cell having a bipolar plate subdivided into at least two reaction areas. Typically multiple fuel cells (e.g., having polymer electrolyte membranes, PEM) are combined into stacks to supply the power required for the drive.

### BACKGROUND

An important customer requirement of vehicles is rapid availability of the desired driving power. The tolerable period of time between activation of the ignition lock and startup of the vehicle is in the range of a few seconds. This period of time is still greatly exceeded by existing vehicles equipped with PEM fuel cell stacks for their drive. The main problem is that today's PEM fuel cells usually begin to generate electric power only at a startup temperature above approx. 5° C. Therefore, heating of the electrochemically active zones by an external heat source is always required if the vehicle temperature is below the startup temperature of the fuel cell. Only above approx. 5° C. is a fuel cell in general capable of being heated up to the operating temperature by the process heat generated—and, if necessary, also by the electric power generated.

Fuel cell systems which may be operated at temperatures below 5° C. or even below 0° C. have also become known in the meantime. However, operation under these conditions is extremely difficult and is feasible only with a great technical complexity. In general, the technical complexity required for operation of fuel cells increases disproportionately with a drop in temperature.

Because of the mass and thermal capacity of fuel cell stacks, the required external heating power usually exceeds the available battery power in the vehicle and/or the heating power of onboard heat sources. To avoid the additional cost that would be incurred by expanding these onboard sources, this is achievable only through gradual heating of the fuel cell stacks.

European Patent Application 1009050 A2 describes special configurations of a plurality of fuel cell stacks designed for different operating temperatures (high temperature, HT, and low temperature, LT) and activated in succession at startup from a low temperature range. The externally preheated cooling water and/or cathode gas of the LT stack activated first (having the lowest required operating temperature) is passed through the other HT stack(s) to bring the latter successively to a temperature level above which initiation of the electrochemical reaction becomes possible. The disadvantage of this device is mainly the low voltage level at which the consumer (e.g., electric motor) receives the input electric power because only a few fuel cells (those of the LT stack) are activated at the beginning. A poor efficiency in providing the mechanical driving power and reduced deployment of power are the result. In addition, the process heat of the surfaces in the LT stack which are the first to be electrochemically active is relayed in a comparatively poor manner to the surfaces, which are still too cold to themselves become electrochemically active. The heated cooling medium of the surfaces that have already become active must first be passed through the cold lines and the gas distributor structures before arriving at the surfaces in the HT stack, where it should transfer as much thermal energy as possible for heating and should do so as rapidly as possible. Furthermore, the use of LT and HT stacks having different designs also necessitates an increased manufacturing complexity.

An alternative method is proposed in Japanese Patent Application Publication No. 2001236978 A, where a fuel cell has a liquid (water) flowing through it, this liquid being heatable by an external heating device. In flowing through the cell, the heated liquid delivers thermal energy to the reaction surface of the fuel cell, first in the intake area, so that this partial area of the total area reaches the required operating temperature first. Supported by the reaction taking place in the intake area and the associated evolution of heat in the cell itself, the remainder of the electrode surface gradually reaches the required temperature. With this configuration, it is not necessary to use two different types of fuel cells (LT stack and HT stack). However, it may be a disadvantage here that the reaction surface reaches the operating temperature only gradually (starting from the intake area of the fluid) while the reactants flow over the entire surface area of the cell—i.e., also including the colder regions. The reaction which begins in the intake area generates water which is entrained by the oxidizing agent, for example, and may condense on the cold surface areas of the cell. Wetting of the reaction surface in colder areas may have a negative effect on the diffusion processes to the PEM.

### SUMMARY OF THE INVENTION

An object of the present invention is to provide a fuel cell that may be brought promptly to the operating temperature and overcomes one or more disadvantage described above.

The present invention provides a fuel cell including a bipolar plate, an anode and a cathode, and an electrolyte (e.g., PEM) situated in between, reactants being passed through inlet and outlet ports over the anode and cathode, and a heat transport medium (e.g., water) being passed through the bipolar plate via separate inlet and outlet ports (7, 8). The bipolar plate is subdivided into at least two reaction areas (1, 2), each reaction area having inlet ports (3a, 3b, 5a, 5b) and outlet ports (4a, 4b, 6a, 6b) for the reactants.

According to the present invention the reaction area is divided using advantageous geometries, i.e., configurations of the gas distributors within the fuel cell and the fuel cell stack. This offers the possibility of rapid and targeted heating of defined zones of all fuel cells intended for the drive, so that adequate power at a high voltage level is made available to the vehicle drive (electric motor) within the shortest possible period of time for prompt startup. The high voltage level enables a high efficiency of the electric motor and thus higher dynamics in startup.

According to the present invention, the reaction surfaces (flow fields) of the cells of the stacks are divided into fields, which permit rapid partial operation of the cell. Individual partial areas of the flow fields (preheating areas) are heated with the help of external heating sources to a temperature, which corresponds at least to the startup temperature of the electrochemically active areas, so that the electrochemical fuel cell process begins in these areas.

### BRIEF DESCRIPTION OF THE DRAWING

The present invention is elaborated upon below based on an exemplary embodiment, with reference to the drawings, in which:

FIG. 1 shows a schematic view of a flow field structure of a fuel cell.

### DETAILED DESCRIPTION

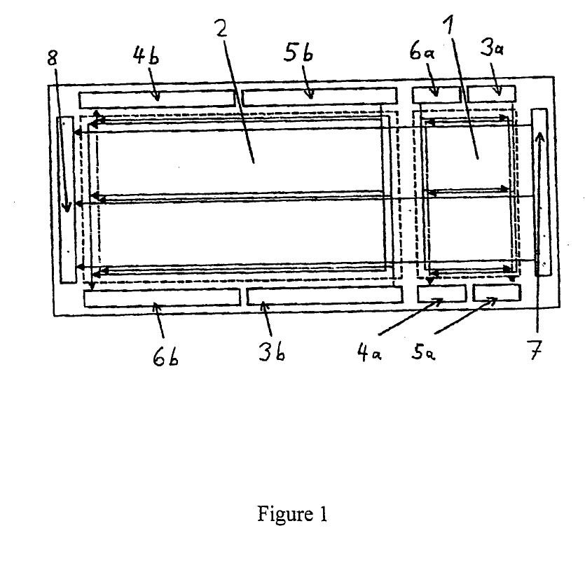

In the embodiment depicted in FIG. 1, the active cell area is subdivided into only two partial areas (as the simplest division), field 1 representing the preheating area described above, which is brought to startup temperature by external sources, and field 2 representing the area which is heated at least partially by process heat and/or the electrically generated power of field 1. A portion of the process heat generated first in field 1 is transported directly by heat conduction to colder field 2.

Cathode gas flows separately into fields 1 and 2 through two oxidizing agent inlet ports 3a, 3b. The oxidizing agent may be air or some other oxygen-containing gas. Likewise, there are two inlet ports 5a, 5b and two outlet ports 6a, 6b for the combustion gas (hydrogen-containing gas). The cooling medium flows through inlet port 7 provided for it, first flowing through the preheating area, where it is heated by the fuel cell process in field 1 shortly after starting up this field. Then it passes through field 2, surrendering most of its heat there and bringing field 2 to the startup temperature, and it leaves the fuel cell through outlet port 8.

During the heating of field 1, this may preferably take place after removing the cooling medium, which may then be supplied back to the cell area shortly before or during operation of field 1. In an embodiment, an extra outlet port for the cooling medium may be provided in field 1 and an extra inlet port for field 2 (not shown) to reduce the mass flow before coolant enters field 2, for example or to add colder coolant.

Another embodiment includes the connection of cathode outlet port 4a of field 1 to cathode inlet port 3b of field 2. This connection may also be provided with a valve which is preferably opened only when field 2 has heated to the extent that there is no longer any risk of the moisture in the incoming gas freezing out or forming undesirable condensation in colder field 2. In another embodiment, anode outlet port 6a of field 1 is connected to anode inlet port 5b of field 2. This connection may also be provided with a valve in a similar manner; this valve is preferably opened only when field 2 has been heated to the extent that there is no longer any risk of the moisture in the incoming gas freezing out or forming unwanted condensation in colder field 2.

The channel structures diagramed schematically between the inlet and outlet ports represent only one possibility of the channel structure design. Serpentine, parallel, branched and/or nubbed structures are also conceivable.

Preferably a separate area like field 1 is preheated in each fuel cell provided for the power supply, so the electric power is available at the maximum voltage level at startup.

Due to the flow field and/or bipolar plate geometry according to the present invention, direct thermal contact is established between the preheating area and the remaining area of the flow fields due to thermal conduction. Therefore, the heat formed as reaction heat by early operation of the preheating area may also be supplied by thermal conduction to the colder area, so that this area may be brought to the startup temperature more rapidly.

In comparison with the configuration according to European Patent 1009050 A2, installation volume may also be saved because it is no longer necessary to use more than one fuel cell stack. This also makes it possible to eliminate bracing devices and gas feeder lines to the stacks.

In another embodiment, reaction area 2 next to preheating area 1 is subdivided into multiple zones, each having separate gas inlet and outlet ports. This makes is possible to include the particular zones successively in the reaction process through the introduction of gas when the temperature has reached the reaction level. Reactions thus take place only in areas having a favorable temperature range.

The fuel cell described here is characterized by a rapid response at unfavorably low temperatures. It is suitable in particular for use in motor vehicles, where power must be made available rapidly in a cold start. The chemical reactions take place only on activated surface areas having an advantageous temperature, so the conversion of reactants and thus the efficiency are in a favorable range. Local overwetting of the membrane due to condensation water may be largely avoided.

What is claimed is:

1. A fuel cell comprising:
an anode;
a cathode, the cathode and the anode being capable of receiving an electrolyte therebetween, the cathode and the anode being capable of having respective reactants passed over them; and
a bipolar plate, the bipolar plate being subdivided into a plurality of reaction areas, each of the reaction areas including a respective reactant inlet port and a respective reactant outlet port for each of the respective reactants, the bipolar plate being capable of having a heat transport medium passed therethrough via a heat transport medium inlet and a heat transport medium outlet port.

2. The fuel cell as recited in claim 1 wherein the electrolyte includes a polymer electrolyte membrane.

3. The fuel cell as recited in claim 1 wherein the heat transport medium includes water.

4. The fuel cell as recited in claim 1 wherein a first of the plurality of reaction areas is capable of having the heat transport medium passed therethrough via the heat transport medium inlet and outlet ports, and wherein a second of the plurality of reaction areas is capable of having a heat transport medium passed therethrough via a second heat transport medium inlet port and a second heat transport medium outlet port, and further comprising a flow control device configured to separately control respective flows of the heat transport medium over the first and second reaction areas.

5. The fuel cell as recited in claim 1 further comprising a flow control device configured to vary a flow rate of the heat transport medium.

6. The fuel cell as recited in claim 1 further comprising a temperature measuring device configured to measure a respective temperature of each of the plurality of reaction areas.

7. The fuel cell as recited in claim 6 further comprising a flow control device configured to influence a flow of at least one of the respective reactants and the heat transport medium as a function of at least one of the respective measured temperatures.

8. A method of activating a fuel cell, the fuel cell including an anode, a cathode and a bipolar plate, the bipolar plate being subdivided into a plurality of reaction areas, the method comprising:
heating a first of the reaction areas to a reaction temperature by the heat transport medium;
providing reactants initially only to the first reaction area; and
providing a second of the reaction areas with the reactants after the second reaction area has been heated to the reaction temperature.

9. The method as recited in claim 8 wherein the providing the second of the reaction areas with the reactants is performed so that the reactants flow in succession over the first and second reaction areas.

10. The method as recited in claim 8 wherein the providing the second of the reaction areas with the reactants is performed so that the reactants flow over the first and second reaction areas in parallel.
